(19) United States
(12) Patent Application Publication
(10) Pub. No.: US 2014/0219424 A1
(43) Pub. Date: Aug. 7, 2014

(54) Electron Beam Focusing and Centering

(71) Applicant: Moxtek, Inc., Orem, UT (US)

(72) Inventors: Gordon Smith, Sandy, UT (US); William H. Hansen, Manteca, CA (US); Sterling W. Cornaby, Springville, UT (US)

(73) Assignee: Moxtek, Inc., Orem, UT (US)

(21) Appl. No.: 14/080,304

(22) Filed: Nov. 14, 2013

Related U.S. Application Data
(60) Provisional application No. 61/760,452, filed on Feb. 4, 2013.

(51) Int. Cl. H01J 35/14

(52) U.S. Cl. CPC H01J 35/14
USPC 378/137

(57) ABSTRACT

A method and device for control of an electron beam flux, electron spot size, and/or electron spot location. Electromagnetic radiation from an anode of the x-ray tube can be focused on a detector. The detector can send a signal to a control module based on the electromagnetic radiation focused on the detector. The control module can control the electron beam with a beam control device and/or a current control device. The signal can also indicate anode temperature at the electron spot.

### CLAIM OF PRIORITY

This claims priority to U.S. Provisional Patent Application No. 61/760,452, filed on Feb. 4, 2013, which is incorporated herein by reference in its entirety.

### FIELD OF THE INVENTION

The present application is related generally to x-ray sources, and especially to electron spot control.

### BACKGROUND

X-rays can be produced by accelerating electrons (in an electron beam) from an electron emitter of a cathode to an anode in an evacuated x-ray tube. The anode can include a target material that will produce x-rays in response to impinging electrons. Upon striking the target material, the electrons of the electron beam can knock target electrons out of their shells. Electrons in higher shells in each atom can then drop to fill the now empty shells. As the electrons drop to lower shells, x-rays can be emitted.

An important feature of x-ray sources is a spot size where a majority of electrons impinge upon the target (electron spot size). The electron spot size can correlate to an x-ray spot size where emitted x-rays hit a sample. Different x-ray uses have different requirements of x-ray spot size. Some applications may require very small spot sizes, such as around 50 micrometers for example. A challenge of providing such small spots is that the spot size is typically very carefully controlled in order to meet the demands of the application for a small spot. If the spot size is too big, it may not meet the needs of the application; however, if the spot size is too small then the anode target can be burned by too high a power density. Another important feature of x-ray sources is control of a location where the electrons impinge on the target (electron spot location).

See for example U.S. Pat. No. 4,979,199.

### SUMMARY

It has been recognized that it would be advantageous to provide an x-ray source with good control of electron spot size and location. The present invention is directed to an x-ray source, and a method for control of an electron beam within an x-ray tube, that satisfy these needs.

In one embodiment, the x-ray source comprises an x-ray tube, a control module, a detector, and a lens. The x-ray tube includes an anode attached to an evacuated enclosure; an electron emitter attached to the evacuated enclosure; and a beam control device disposed between the electron emitter and the anode. There may be a gap between the beam control device and the electron emitter and a gap between the anode and the beam control device. The electron emitter can be configured to emit electrons towards the anode. The anode can be configured to emit electromagnetic radiation through the lens towards the detector. The lens can be configured to focus, and the detector configured to detect, the electromagnetic radiation emitted from the anode onto the detector. The beam control device and the detector can be electrically coupled to a control module. The control module can be capable of providing a voltage to the beam control device; receiving a signal from the detector, the signal indicating an electron spot size where the electron beam impinges on the anode; and modifying the voltage to the beam control device to change a diameter of the electron beam based on the signal from the detector and an electron spot size setpoint.

### BRIEF DESCRIPTION OF THE DRAWINGS

FIG. 1 is a schematic cross-sectional side view of an x-ray source with a transmission anode target, in accordance with an embodiment of the present invention;

FIG. 2 is a schematic cross-sectional side view of an x-ray source with a reflection anode target, and a side window, in accordance with an embodiment of the present invention;

FIG. 3 is a schematic showing a control module capable of providing voltage to two separate segments of a beam control device, disposed on opposite sides of an axis (approximate center of an electron beam) between an electron emitter and an anode, in accordance with an embodiment of the present invention;

FIG. 4 is a schematic showing the control module capable of providing voltage to three separate segments of a beam control device, disposed substantially uniformly around the axis between the electron emitter and the anode, in accordance with an embodiment of the present invention;

FIG. 5 is a schematic showing the control module capable of providing voltage to four separate segments of a beam control device, disposed substantially uniformly around the axis between the electron emitter and the anode, in accordance with an embodiment of the present invention;

FIG. 6 is a schematic showing the control module providing controlled voltage to a beam control device for control of electron beam trajectory and/or diameter, in accordance with an embodiment of the present invention;

FIG. 7 is a schematic the control module providing controlled voltage to a flux control device for control of electron beam flux, in accordance with an embodiment of the present invention;

FIG. 8 is a schematic showing a method for controlling an electron spot size and/or location on an anode, by controlling the source electron beam, in accordance with an embodiment of the present invention;

FIG. 9 is a schematic is a schematic showing a method for controlling an electron beam flux, in accordance with an embodiment of the present invention;

FIG. 10 is a schematic cross-sectional side view of an x-ray source and control module, in accordance with an embodiment of the present invention; and

FIG. 11 is a schematic cross-sectional side view of an x-ray source and control module, in accordance with an embodiment of the present invention.

### DEFINITIONS

“Spot size” as used herein in reference to an x-ray spot size or an electron spot size on a target means the full width half max measurement (FWHM) of the spot. In other words, on a plot of the spot intensity, the spot size is the width (diameter) at half of full (maximum) intensity.

### REFERENCE NUMBERS SHOWN IN THE FIGURES

1 x-ray tube
2 camera
3 lens
4 detector
5 substantially evacuated enclosure
6 gap between anode and beam control device
7 gap between beam control device and flux control device
8 gap between electron emitter and beam control device and/or flux control device
11 anode
12 cathode
13 electron emitter
14 axis between the electron emitter and the anode, or approximate center of an electron beam
15 control module
16 beam control device(s)
17 flux control device
18 electromagnetic radiation emitted from the anode to the detector
19 x-rays
21 wires
24 window for transmission of x-rays out of the enclosure (“x-ray window)
25 electron spot
26 electron beam
27 window for transmission of electromagnetic radiation emitted from the anode to the detector (“detector window”)
28 temperature level output
61 electron spot location setpoint
62 electron spot size setpoint
63 voltage provided by the control module to the beam control device
64 Input to electron spot size setpoint
65 Input to electron spot location setpoint
66 control of electron beam trajectory and/or diameter
67 control of electron spot location and/or size on the anode target
68 control of x-ray spot location and/or size
69 signal from the detector to the control module, indicated electron spot size, electron spot location, and or anode temperature
71 flux setpoint
72 measured flux
73 voltage provided by the control module to the flux control device
74 operator input to flux setpoint
76 control of electron beam flux
78 control of x-ray flux
d pinhole diameter
D electron beam diameter

### DETAILED DESCRIPTION

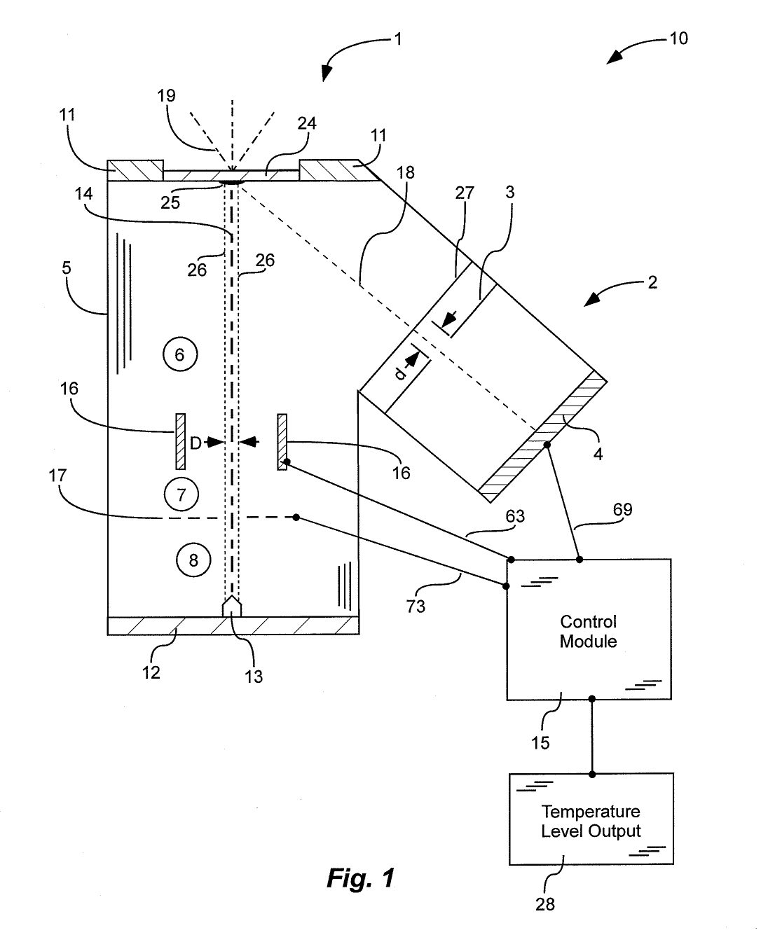

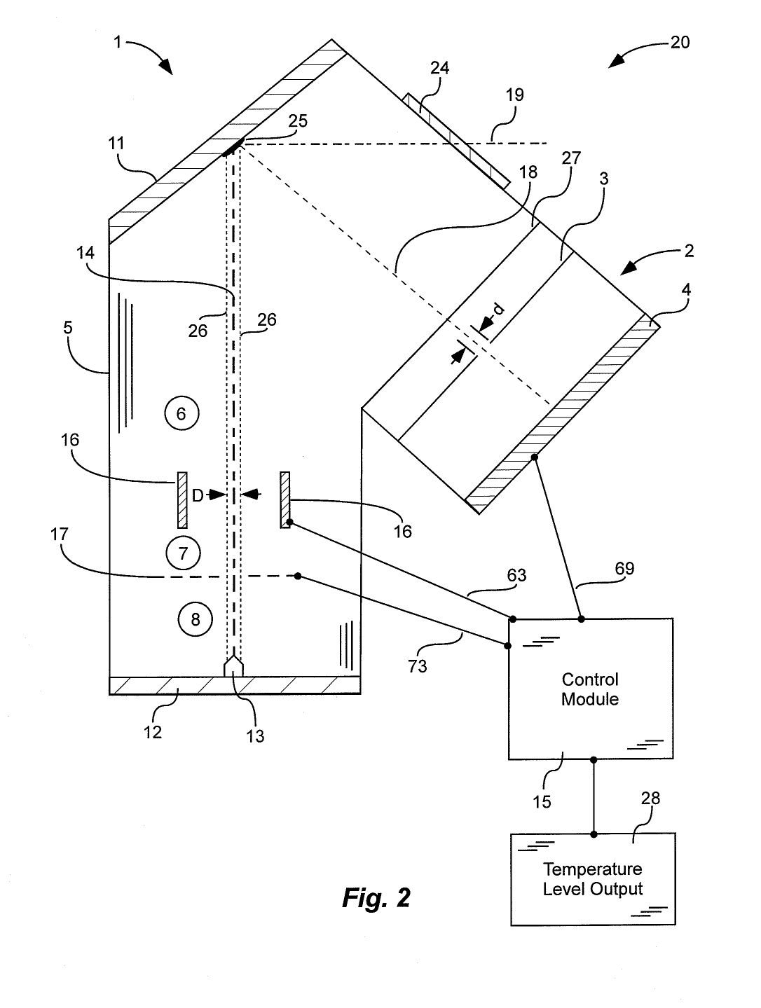

As illustrated in FIGS. 1 and 2, x-ray sources 10 and 20 are shown comprising an x-ray tube 1 and a control module 15. The x-ray tube 1 can include an anode 11 and a cathode 12 attached to a substantially evacuated enclosure 5. The cathode 12 can include an electron emitter 13 configured to emit electrons towards the anode 11. The anode 11 can include a target material for production of x-rays 19 in response to electron bombardment. An electron spot 25 can be formed on the anode 11 where the electrons impinge upon or bombard the anode 11. The electron spot 25 has a size and location on the anode 11.

The x-ray sources 10 and 20 can include control devices comprising a beam control device 16 and a flux control device 17. The control devices 16 and 17 can be disposed between the electron emitter 13 and the anode 11. The beam control device 16 can be used to control electron beam 26 trajectory and/or width (and thus also electron spot 25 location and/or size on the anode 11). Normally, the flux control device 17 will be disposed between the beam control device 16 and the electron emitter 13, but the opposite configuration is within the scope of this invention. The flux control device 17 can be used for control of electron beam 26 flux within the x-ray tube 1. The flux control device 17 and/or the beam control device 16 can be made of electrically conducting materials such as metal, a semiconductor material doped to achieve a desired level of conductivity, or other types of conductors such as carbon. The electron emitter 13 can be configured to emit electrons through the control devices towards the anode 11.

There can be a gap 8 between one of the control devices (beam control device 16 and/or flux control device 17) and the electron emitter 13. There can be a gap 6 between one of the control devices (beam control device 16 and/or flux control device 17) and the anode 11. There can be a gap 7 between the flux control device 17 and the beam control device 16 (if both a beam control device 16 and a flux control device 17 are used). The gaps 6, 7, and 8 can allow each of the electron emitter 13, the beam control device 16, the flux control device 17, and the anode 11, to be operated at different voltages relative to each other.

A detector 4 and a lens 3 can be disposed in a position to receive electromagnetic radiation 18 from the anode 11. The electromagnetic radiation 18 can pass in a single straight-line path from the anode 11 to the detector 4. The electromagnetic radiation 18 from the anode 11 can be emitted from an x-ray window 24 portion of the anode, as shown in FIG. 1. The detector 4 can face the anode 11 and the lens can be disposed between the detector and the anode. The detector 4 and the lens 3 can comprise components of a camera 2. The anode 11 can emit electromagnetic radiation 18 through the lens 3 towards the detector 4. The lens 3 can focus the electromagnetic radiation 18 onto the detector 4, and the detector 4 can detect the electromagnetic radiation 18. In one embodiment, the lens 3 can be a pinhole type of lens. In one embodiment, the pinhole can have a diameter d of between 3 to 30 micrometers. In another embodiment, the lens can be a focusing optic, such as a glass lens.

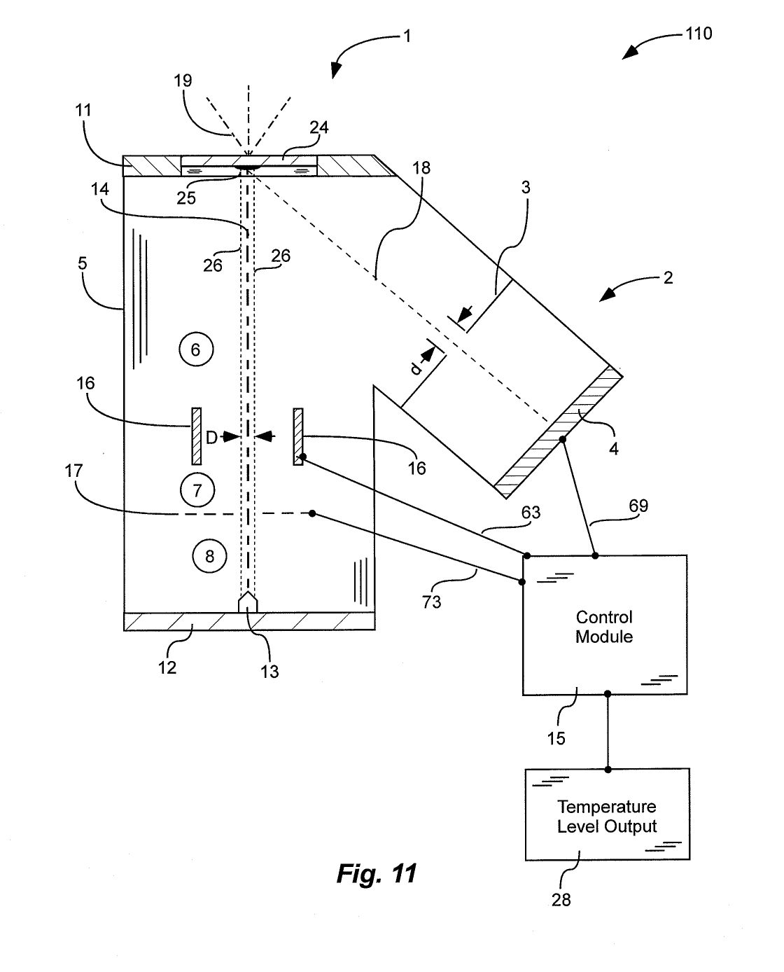

In one embodiment, the detector 4 and the lens 3 can be disposed at least partly within the substantially evacuated enclosure 5 of the x-ray tube 1, and thus at least part of the detector 4 and the lens 3 can be subjected to vacuum, and can be subjected to substantially the same vacuum as the electron emitter 13. In another embodiment, a detector window 27 can separate the lens 3 and detector 4 from the vacuum of the evacuated enclosure 5. The detector window 27 can be designed to pass the type of electromagnetic radiation 18 detected by the detector 4. Thus, the detector window 27 is optional. For clarity, shown in FIG. 11 is x-ray source 110, which is similar to x-ray source 10 in FIG. 1, but without the detector window 27. Similarly, the detector window 27 may be removed from the side window x-ray source 20 shown in FIG. 2.

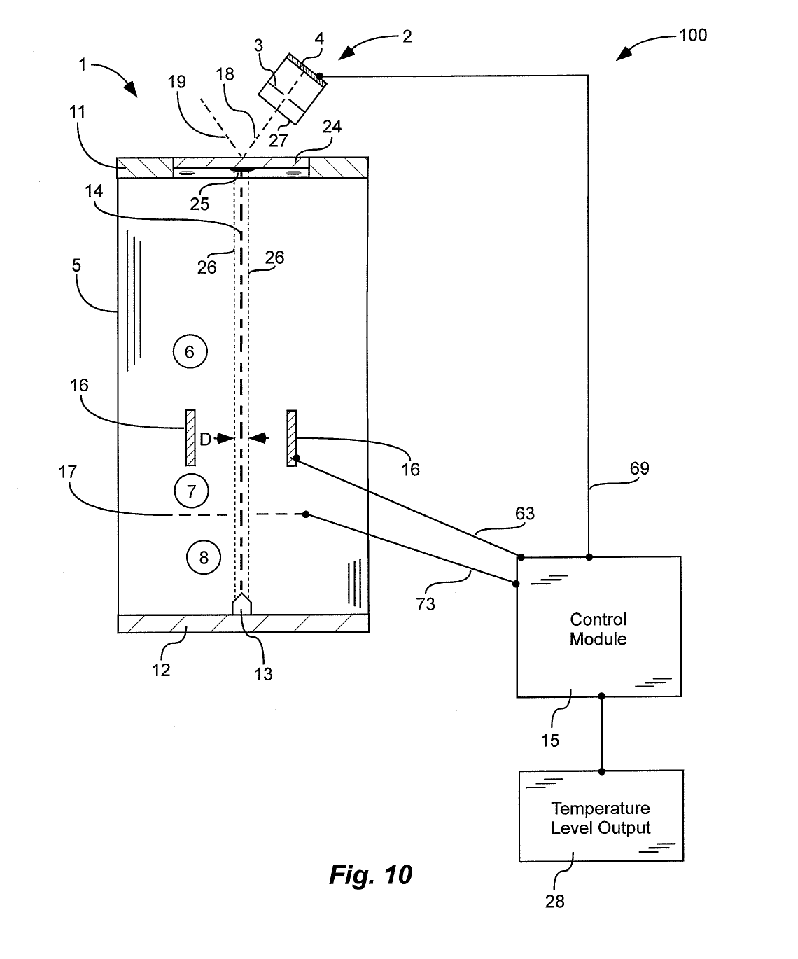

As shown in FIG. 10 on x-ray source 100, the detector 4 and lens 3 need not be attached to the enclosure 5 nor be part of the x-ray tube, but rather the camera 2, detector 4, and lens 3 can be a physically separate unit. In this embodiment, the electromagnetic radiation 18 focused by the lens 3 on the detector 4 can be the x-rays 19 emitted from the x-ray tube. Although FIG. 10 shows an end window transmission anode design, this type of design, in which the detector 4 and lens 3 are not part of the x-ray tube 1, can also be used with a side window x-ray tube. In contrast, as shown in FIGS. 1-2, the detector 4 and lens 3 can be attached to the enclosure 5 and can be part of the x-ray tube.

Whether the detector 4 and the lens 3 are disposed at least partly within the substantially evacuated enclosure 5 and subjected to vacuum, or separated from the substantially evacuated enclosure 5 by a detector window 27, or whether the detector 4 and the lens 3 are or are not part of the x-ray tube 1, may depend on manufacturing considerations, product size constraints, material cost, and the effect of the substantially evacuated enclosure 5 vacuum on the detector 4.

The electromagnetic radiation 18 emitted by the anode 11, received by the detector 4, and focused on the detector 4 by the lens 3 can be used to show electron spot 25 size and/or location on the anode 11. The electromagnetic radiation 18 emitted through and focused by the lens 3 and received by the detector 4 can be various types of electromagnetic radiation 18, including infrared light, visible light, ultraviolet light, and x-rays. The lens 3 can be configured to focus, and the detector 4 can be configured to detect, any of these types of electromagnetic radiation 18.

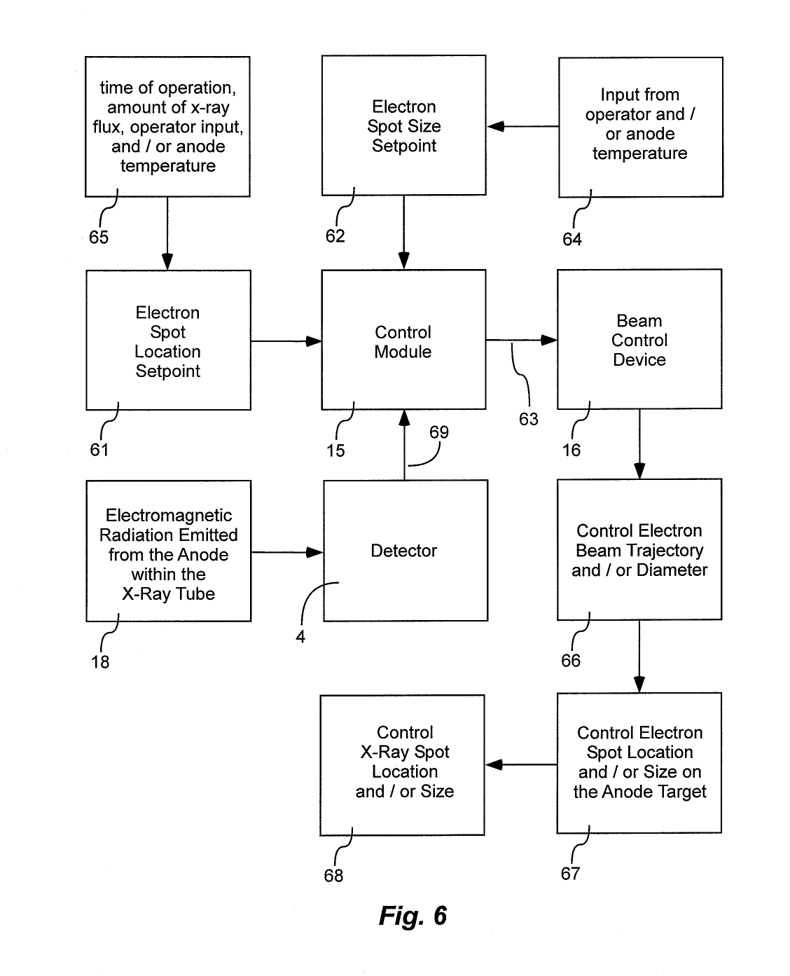

The beam control device 16 can be electrically coupled to a control module 15. The control module 15 can be electrically coupled to the detector 4 and can receive a signal 69 (FIG. 6) from the detector 4. The signal 69 can be based on the electromagnetic radiation 18 emitted from the anode 11 onto the detector 4 and can indicate the electron spot 25 size and/or location where the electron beam 26 impinges on the anode 11.

The signal 69 from the detector 4 can further indicate a temperature of the anode 11. Typically the detector 4 would detect infrared radiation for determination of anode 11 temperature. The control module can then provide a temperature level output 28. This temperature level output 28 can be displayed for an operator to see. The temperature level output 28 can also be used as an alert or alarm. If the anode 11 temperature at the electron spot 25 is too high, and thus the anode 11 is in danger of being damaged, then the electron spot 25 size can be increased, the electron spot location 25 can be changed, and/or the electron beam 26 flux can be reduced. The previous mentioned changes can be done automatically based on anode 11 temperature at the electron spot, or can be done with operator intervention.

The beam control device 16 can be a single electrically conductive plate, or multiple electrically conductive plates. The plate(s) can be disposed with a face thereof facing an axis 14 between the electron emitter 13 and the anode 11, or approximate center of the electron beam 26. Alternatively, a single plate with a hole for passage of the electron beam 26 may be used, with a face of the plate perpendicular to the axis 14 between the electron emitter 13 and the anode 11, or approximate center of the electron beam 26 (typically used if electron spot 25 size control, but not electron spot 25 location control, is desired). Alternatively, the beam control device 16 can be separate metal wire segments. The beam control device 16 can be a coil of wire, or multiple separate coils of wire, instead of, or in conjunction with, the plate(s). An electric current through the wires can produce an electromagnetic field, which can be used for control of the electron beam 26.

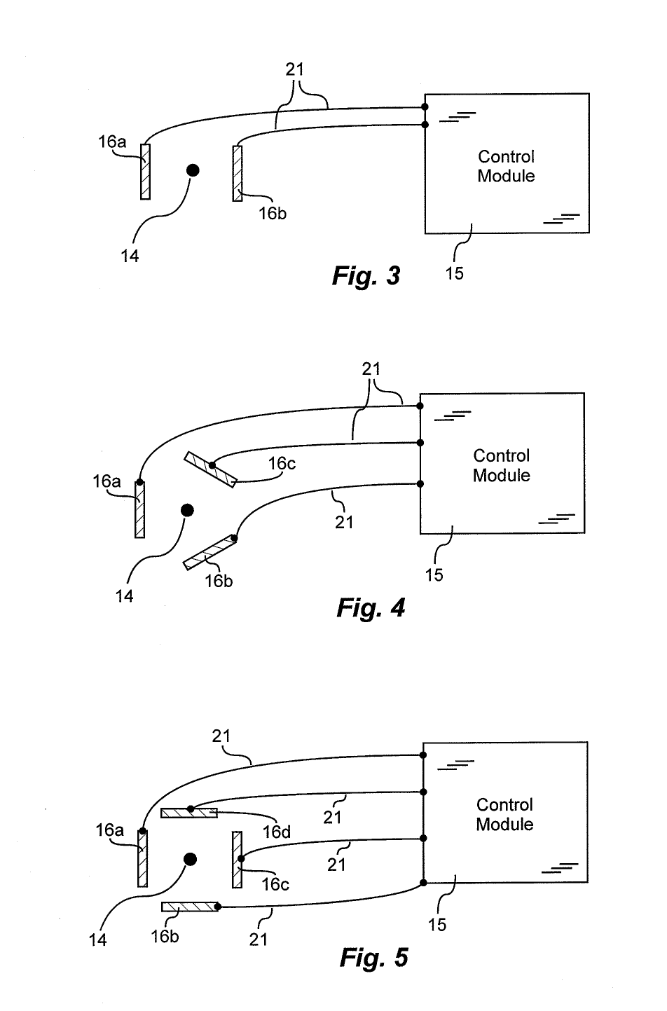

FIGS. 3-6, and the following description, further provide details of electron beam 26 control (and thus electron spot 25 size and/or location control) through use of the beam control device 16. The control module 15 can provide a voltage 63 (FIG. 6) to the beam control device 16, and can modify this voltage 63 to change a trajectory of the electron beam 26 based on the signal 69 from the detector 4 and an electron spot location setpoint 61. There can be a single electron spot location setpoint 61 for the life of the x-ray source, for maintaining a constant electron spot location in spite of changes in environment or rough handling of the x-ray source. Alternatively, the electron spot location setpoint 61 can be changed based on x-ray source time of operation (e.g. total time of operation at that electron spot location), amount of x-ray 19 flux (e.g. sum total x-ray flux at that electron spot location), operator input, and/or anode 11 temperature (see 65 in FIG. 6). Changing the electron spot location setpoint 61 can allow for optimum use of the anode 11, by allowing a change of electron spot 25 from one location to another as the anode 11 target material wears out in the prior location. Changing the electron spot location setpoint 61 can allow for diversity of use of the x-ray source, such as if one region of the anode 11 has one thickness and/or material, and another region has a different thickness and/or material.

A beam control device 16 made of a single segment may be used, such as a plate with a hole in the center, but such a device might not provide the desired control of electron beam 26 trajectory. A beam control device 16 made of a single segment, disposed on one side of the electron beam 26 may provide some control of electron beam 26 trajectory, but multiple segments may provide better control. Multiple beam control segments 16a-d, with the ability of the control module 15 to send a different voltage to each, used for controlling electron beam 26 trajectory, are shown in FIGS. 3-5. The individual segments can be electrically isolated from each other, and thus each segment can have a different voltage from other segments.

As shown in FIG. 3, the beam control device 16 can include two separate segments 16a-b. The two separate segments 16a-b can be disposed on opposite sides of an axis 14 between the electron emitter 13 and the anode 11, or approximate center of the electron beam 26. The control module 15 can send a different voltage to each segment 16a-b (through wires 21) to cause the electron beam 26 to shift one direction or another for control of electron beam 26 trajectory, and thus of electron spot 25 location, and ultimately x-ray 19 spot location.

As shown in FIG. 4, the beam control device 16 can include three separate segments 16a-c, which can be disposed substantially uniformly around the axis 14 or approximate center of the electron beam 26. The control module 15 can send a different voltage to at least one segment 16a-c (through wires 21) relative to at least one of the other segments to cause the electron beam 26 to shift one direction or another for control of electron beam 26 trajectory, and thus for control of electron spot 25 location, and ultimately for control of x-ray 19 spot location. Three beam control devices 16a-c can provide control in more directions, and thus achieve better overall control, than two beam control devices 16a-b.

As shown in FIG. 5, the beam control device 16 can include four separate segments 16a-d which can be disposed substantially uniformly around the axis 14 or approximate center of the electron beam 26. The control module 15 can send a different voltage to at least one segment 16a-d (through wires 21) relative to at least one other of the segments 16a-d to cause the electron beam 26 to shift one direction or another for control of electron beam 26 trajectory, and thus for control of electron spot 25 location, and ultimately for control of x-ray 19 spot location. Four beam control segments 16a-d can provide control in more directions, and thus achieve better overall control, than three beam control segments 16a-b.

More than four beam control segments can be used for improved beam control, but circuitry can be more complicated, in order have the ability to provide a separate voltage to the various segments of the beam control device 16. Also, manufacturing may be more complicated with more segments of the beam control device 16. These issues may be considered in determining the number of segments of the beam control device 16 for a particular design. The control module 15 can provide a voltage 63 to the beam control device 16, and can modify this voltage 63 to change a diameter D of the electron beam 26 based on the signal 69 from the detector 4 and an electron spot size setpoint 62. The electron spot size setpoint 62 can be modified by various ways such as by operator input 64 and/or anode temperature. Thus, if the detector 4 and the control module 15 show that the electron spot 25 size out of the range of the electron spot size setpoint 62, the electron spot 25 size can be modified by the control module 15 making the beam control device 16 voltage 63 relatively more negative or relatively more positive. If the voltage change causes the spot size to go in the wrong direction, as indicated the by signal 69 from the detector 4, then the control module 15 can cause the voltage 63 to change in the opposite direction (relatively more positive or relatively more negative). Thus, the electron spot 25 size can be controlled by the signal 69 from the detector 4 to the control module 15 and by the control module 15 modifying the voltage 63 to the beam control device 16.

Unlike changing voltage for electron beam 26 trajectory control, in which control can be performed by a relative difference of voltage of one beam control device 16 with respect to another, all beam control devices 16 can have a uniform increase or decrease in voltage for electron spot 25 size control. If only a single beam control device 16 is used, such as a hole in a plate for example, then the voltage of this plate can be increased or decreased for electron spot 25 size control.

Control of electron beam 26 trajectory and of electron spot 25 size may be accomplished simultaneously, by raising or lowering the voltage 63 of one or some segment(s) of the beam control device 16 with respect to other segment(s) of the beam control device 16 for trajectory control, and also raising or lowering the voltage 63 of all segments of the beam control device 16 uniformly for electron spot 25 size control. Thus, the control module 15 can control voltage 63 to the beam control device 16, which can control electron beam 26 trajectory and/or diameter (see 66 in FIG. 6), which can control electron spot location and/or size on the anode target (see 67 in FIG. 6), which can control x-ray spot location and/or size (see 68 in FIG. 6).

The x-ray sources described herein, with feedback of electron spot 25 size, can be used to produce very small, and tightly controlled, electron spot 25 sizes on the anode 11, and thus very small x-ray 19 spot sizes. This can be accomplished by use of feedback from the detector 4 indicating actual electron spot 25 size, which can be used to control the electron spot 25 size within relatively tight tolerances. The x-ray sources described herein can produce and tightly control an x-ray 19 spot size of between 20 to 80 micrometers in one embodiment or between 5 and 100 micrometers in another embodiment. The x-ray sources described herein can also produce and tightly control other x-ray spot sizes.

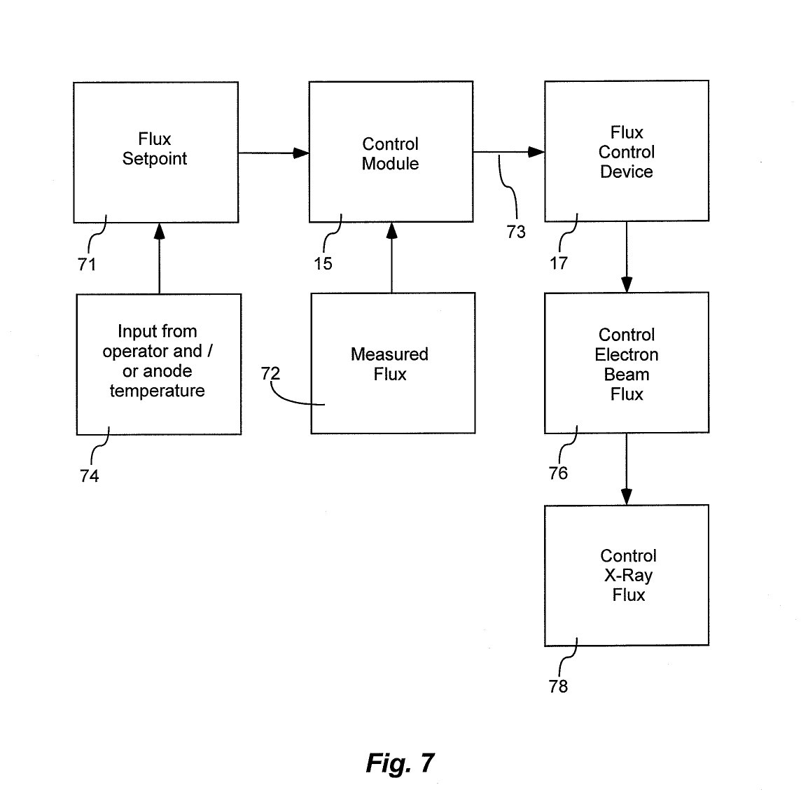

As illustrated in FIGS. 1, 2, 7, 10, and 11, the flux control device 17 can be electrically coupled to the control module 15. The control module 15 can provide a voltage 73 to the flux control device 17 based on a flux setpoint 71. The flux setpoint 71 can be an electron beam 26 flux setpoint or an x-ray 19 flux setpoint. The control module 15 can receive a measurement of present electron beam 26 flux (measured flux 72) such as by, for example, measuring electrical current through a high voltage multiplier used for providing high negative voltage to the electron emitter 13 or by measuring electrical current between the anode 11 and ground. Such measurements can show the electrical current between the electron emitter 13 and the anode 11 through the x-ray tube 1, and can be defined as measured electron beam 26 flux. Alternatively, the control module 15 can receive a measurement of present x-ray 19 flux (measured x-ray 19 flux), by measuring x-ray 19 flux output from the x-ray source, such as with an x-ray detector, for example. The measured electron beam 26 flux and/or the measured x-ray 19 flux is referred to as “measured flux” 72 in FIG. 72. The control module 15 can then modify the voltage 73 to the flux control device 17 based on the measured flux 72 and the flux setpoint 71. In one embodiment, the flux setpoint 71 can be modified or set based on input from operator and/or anode temperature (see 74 in FIG. 7).

If the measured flux 72 is too high relative to the flux setpoint 71 (measured flux 72>flux setpoint 71), the control module 15 can cause the voltage 73 on the flux control device 17 to become relatively more negative, which can reduce electron beam 26 flux and consequently also reduce x-ray 19 flux. If the measured flux 72 is too low relative to the flux setpoint 71 (measured flux 72<flux setpoint 71), the control module 15 can cause the voltage 73 on the flux control device 17 to become relatively more positive, which can increase electron beam 26 flux and consequently also increase x-ray 19 flux. Thus, the control module 15 can control voltage 73 to the flux control device 17, which can control electron beam flux (see 76 in FIG. 7), which can control x-ray flux (see 78 in FIG. 7).

In one embodiment in which the x-ray source includes both a beam control device 16 and a flux control device 17, the control module 15 can provide a voltage to the flux control device 17 that is more negative than a voltage at the electron emitter 13 and a voltage to the beam control device 16 that may be more positive than, or less positive than, a voltage at the electron emitter 13.

In one embodiment, the control module 15 can be capable of, or configured for, some or all of the following:
1. providing a voltage 63 to the beam control device 16;
2. receiving a signal 69 from the detector 4 based on the electromagnetic radiation 18 emitted from the anode 11 onto the detector 4, the signal 69 indicating an electron spot 25 size and/or an electron spot 25 location where the electron beam 26 impinges on the anode 11;
3. modifying the voltage 63 to the beam control device 16 to change a trajectory of the electron beam 26 based on the signal 69 from the detector 4 and an electron spot location setpoint 61;
4. modifying the voltage 63 to the beam control device 16 to change a diameter D of the electron beam 26 based on the signal 69 from the detector 4 and an electron spot size setpoint 62;
5. providing a voltage 73 to the flux control device 17;
6. receiving a measurement of present electron beam flux or x-ray flux (“measured flux”) 72; and
7. modifying the voltage 73 to the flux control device 17 based on the measured flux 72 and a flux setpoint 71.

The various embodiments described herein can be used with a transmission window x-ray tube, as shown in FIGS. 1, 10, and 11, in which x-rays 19 are emitted from the x-ray tube 1 through the an x-ray window 24 portion of the anode 11 in substantially the same direction as electrons travel in the electron beam 26 within the x-ray tube 1. The various embodiments described herein can also be used with a reflection/side window x-ray tube, as shown in FIG. 2, in which in which x-rays 19 are emitted from the anode 11 through a portion of the substantially evacuated enclosure 5 and then out through an x-ray window 24. The emitted x-rays 19 can be emitted primarily in a direction different from the direction electrons travel in the electron beam 26 within the x-ray tube 1.

### Method

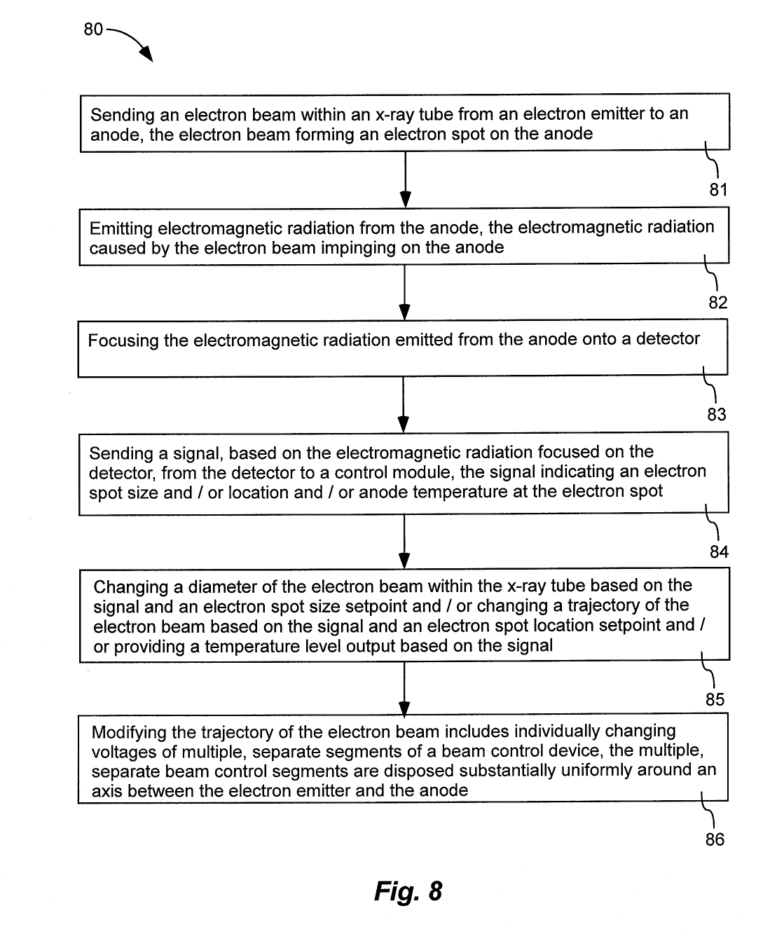

A method 80 for control of an electron beam 26 within an x-ray tube 1 can be used for control of electron spot 25 size and/or location on the anode 11, by controlling the electron beam 26. As shown in FIG. 8, the method 80 can comprise some or all of the following:
81. Sending an electron beam 26 within the x-ray tube 1 from an electron emitter 13 to an anode 11, the electron beam 26 forming an electron spot 25 on the anode 11.
82. Emitting electromagnetic radiation 18 from the anode 11, the electromagnetic radiation 18 caused by the electron beam 26 impinging on the anode 11. The electromagnetic radiation 18 can emit from an x-ray window 24 portion of the anode 11.
83. Focusing the electromagnetic radiation 18 emitted from the anode 11 onto a detector 4. The electromagnetic radiation 18 can transmit solely within the evacuated enclosure from the anode to the detector.
84. Sending a signal 69, based on the electromagnetic radiation 18 focused on the detector 4, from the detector 4 to a control module 15, the signal 69 indicating an electron spot 25 size and/or location and/or anode 11 temperature at the electron spot 25 location.
85. Changing a diameter of the electron beam 26 within the x-ray tube 1 based on the signal 69 and an electron spot size setpoint 62 and/or changing a trajectory of the electron beam 26 based on the signal 69 and an electron spot location setpoint 61 and/or providing a temperature level output 28 based on the signal 69.
86. Modifying the trajectory of the electron beam 26 can further include individually changing voltages of multiple, separate segments of a beam control device 16, the multiple, separate segments being disposed substantially uniformly around an axis 14 between the electron emitter 13 and the anode 11.

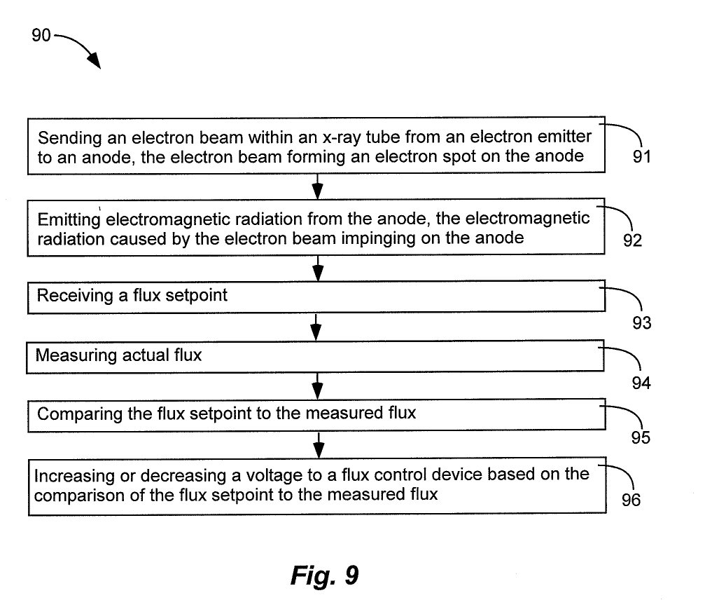

As shown in FIG. 9, a method 90 for control of an electron beam 26 flux within an x-ray tube 1 can comprise some or all of the following:
91. Sending an electron beam 26 within the x-ray tube 1 from an electron emitter 13 to an anode 11, the electron beam 26 forming an electron spot 25 on the anode 11.
92. Emitting electromagnetic radiation 18 from the anode 11, the electromagnetic radiation 18 caused by the electron beam 26 impinging on the anode 11. The electromagnetic radiation 18 can emit from an x-ray window 24 portion of the anode 11.
93. Receiving a flux setpoint 71 (x-ray 19 flux setpoint or electron beam 26 flux setpoint);
94. Measuring actual flux (“measured flux” 72, which can be x-ray 19 flux or electron beam 26 flux).
95. Comparing the flux setpoint 71 to the measured flux 72.
96. Increasing or decreasing a voltage 73 to a flux control device 17 based on the comparison of the flux setpoint 71 to the measured flux 72.

What is claimed is:

1. An x-ray source comprising:
a. an x-ray tube including:
i. an anode attached to an evacuated enclosure;
ii. an electron emitter attached to the evacuated enclosure;
iii. control devices comprising a beam control device and a flux control device;
iv. the control devices disposed between the electron emitter and the anode;
v. a gap between the control devices and the electron emitter, a gap between the control devices and the anode, and a gap between the flux control device and the beam control device;
vi. the electron emitter configured to emit electrons through the control devices towards the anode;
vii. a detector and a lens attached to and disposed at least partly within the evacuated enclosure;
viii. the anode configured to emit electromagnetic radiation within the evacuated enclosure through the lens to the detector, the lens configured to focus and the detector configured to detect the electromagnetic radiation;
b. the flux control device, the beam control device, and the detector electrically coupled to a control module;
c. the control module capable of:
i. providing a voltage to the flux control device;
ii. providing a voltage to the beam control device;
iii. receiving a signal from the detector based on the electromagnetic radiation emitted from the anode onto the detector;
iv. the signal indicating an electron spot size and an electron spot location where the electron beam impinges on the anode;
v. modifying the voltage to the beam control device to change a trajectory of the electron beam based on the signal from the detector and an electron spot location setpoint; and
vi. modifying the voltage to the beam control device to change a diameter of the electron beam based on the signal from the detector and an electron spot size setpoint.

2. The x-ray source of claim 1, wherein the electromagnetic radiation from the anode is emitted from a window portion of the anode.

3. The x-ray source of claim 1, wherein the detector faces the anode and the electromagnetic radiation passes in a single straight-line path from the anode to the detector.

4. The x-ray source of claim 1, wherein the beam control device comprises at least three separate segments disposed substantially uniformly around an axis between the electron emitter and the anode and the control module is configured to send a separate voltage to each separate segment for control of the electron beam trajectory.

5. The x-ray source of claim 1, wherein, the electron spot location setpoint is changed based on x-ray source total time of operation at an electron spot location, amount of sum total x-ray flux at an electron spot location, operator input, anode temperature at the electron spot location, or a combination thereof.

6. The x-ray source of claim 1, wherein the control module receives a measurement of present electron beam flux or x-ray flux, and the control module modifies the voltage to the flux control device based on the measurement and a flux setpoint.

7. The x-ray source of claim 1, wherein:
a. the signal from the detector further indicates a temperature of the anode at a location of the electron spot; and
b. the control module provides a temperature level output.

8. An x-ray source comprising:
a. an x-ray tube including:
i. an anode attached to an evacuated enclosure;
ii. an electron emitter attached to the evacuated enclosure;
iii. a beam control device disposed between the electron emitter and the anode, with a gap between the beam control device and the anode and a gap between the beam control device and the electron emitter;
iv. a detector facing the anode and a lens disposed between the detector and the anode;
v. the electron emitter configured to emit electrons towards the anode;
vi. a detector and a lens attached to and disposed at least partly within the evacuated enclosure;
vii. the anode configured to emit electromagnetic radiation within the evacuated enclosure through the lens to the detector;
viii. the lens configured to focus and the detector configured to detect the electromagnetic radiation;
b. the beam control device and the detector electrically coupled to a control module;
c. the control module capable of:
i. providing a voltage to the beam control device;
ii. receiving a signal from the detector based on the electromagnetic radiation emitted from the anode onto the detector;
iii. the signal indicating an electron spot size where the electron beam impinges on the anode; and
iv. modifying the voltage to the beam control device to change a diameter of the electron beam based on the signal from the detector and an electron spot size setpoint.

9. The x-ray source of claim 8, wherein the electromagnetic radiation from the anode is emitted from a window portion of the anode.

10. The x-ray source of claim 8, wherein the detector faces the anode and the electromagnetic radiation passes in a single straight-line path from the anode to the detector.

11. The x-ray source of claim 8, wherein the detector is configured to detect, and the lens is configured to focus, x-rays emitted from the anode.

12. The x-ray source of claim 8, wherein the detector is configured to detect, and the lens is configured to focus, visible light emitted from the anode.

13. The x-ray source of claim 8, wherein the detector is configured to detect, and the lens is configured to focus, infrared radiation emitted from the anode.

14. The x-ray source of claim 8, wherein:
a. the signal from the detector further indicates a location of the electron spot; and
b. the control module modifies the voltage to the beam control device to change a trajectory of the electron beam based on the signal from the detector and an electron spot location setpoint.

15. The x-ray source of claim 14, wherein the beam control device comprises at least three separate segments disposed substantially uniformly around an axis between the electron emitter and the anode and the control module is configured to send a separate voltage to each segment for control of the electron beam trajectory.

16. The x-ray source of claim 8, further comprising:
a. a flux control device disposed between the beam control device and the electron emitter;
b. a gap between the flux control device and the electron emitter and a gap between the flux control device and the beam control device; and
c. an electrical connection from the control module to the flux control device, the control module capable of providing a voltage to the flux control device, the control module receives a measurement of present electron beam flux or x-ray flux, and the control module modifies the voltage to the flux control device based on the measurement and an electron beam flux setpoint or an x-ray flux setpoint.

17. The x-ray source of claim 8, wherein:
a. the signal from the detector further indicates a temperature of the anode at a location of the electron spot; and
b. the control module provides a temperature level output.

18. A control module for control of an electron beam within an x-ray source, the control module configured to:
a. provide a voltage to a beam control device in the x-ray source;
b. receive a signal from a detector based on electromagnetic radiation emitted from an x-ray window of the x-ray source onto the detector, the signal indicating an electron spot size and an electron spot location where the electron beam impinges on the x-ray window;
c. modify the voltage to the beam control device to change a trajectory of the electron beam based on the signal from the detector and an electron spot location setpoint; and
d. modify the voltage to the beam control device to change a diameter of the electron beam based on the signal from the detector and an electron spot size setpoint.

19. The control module of claim 18, wherein the control module is further configured to:
a. provide a voltage to a flux control device;
b. receive a measurement of present electron beam flux or x-ray flux (“measured flux”); and
c. modify the voltage to the flux control device based on the measured flux and a flux setpoint.

20. The x-ray source of claim 18, wherein:
a. the signal from the detector further indicates a temperature of the anode at a location of the electron spot; and
b. the control module is further configured to provide a temperature level output based on the signal.
